(19) United States
(12) Patent Application Publication
(10) Pub. No.: US 2005/0206505 A1
(43) Pub. Date: Sep. 22, 2005

(54) Medical facility information management apparatus and method

(75) Inventor: Angelo S. Arcaria, Wethersfield, CT (US)

Correspondence Address: BAKER & HOSTETLER LLP;Suite 1100, Washington Square, 1050 Connecticut Avenue, N.W., WASHINGTON, DC, 20036, US

(73) Assignee: Edwards Systems Technology, Inc.

(21) Appl. No.: 10/901,229

(22) Filed: Jul. 29, 2004

Related U.S. Application Data
(63) Continuation-in-part of application No. 10/802,916, filed on Mar. 18, 2004.

(51) Int. Cl. G08B 1/00

(52) U.S. Cl. 340/286.01; 340/506; 340/531

(57) ABSTRACT

A master controller for medical staff management indicators has a central data collection and display facility located at a nurse's station or equivalent facility and includes any number of satellite devices located in examining rooms or the equivalent. Each satellite can respond to master controller polling by sending one of a multiplicity of possible messages that are received and processed to generate a displayed satellite status summary at the nurse's station. Interconnection between the nurse's station and the satellites preferably uses a single twisted pair of wires in a bus configuration compatible with bus standard RS-485. Data rates and message structure are selectable according to system size, environmental noise, and data confidence requirements.

### CROSS-REFERENCE TO RELATED APPLICATIONS

This application claims priority to and is a continuation-in-part of U.S. patent application entitled TWO-WIRE DOME LIGHT POWER AND CONTROL SYSTEM, having a Ser. No. 10/802,916, now pending, the disclosure of which is hereby incorporated by reference in its entirety.

### FIELD OF THE INVENTION

The present invention relates generally to remote message display and communication devices. More particularly, the present invention relates to digital communication, control, and display devices for annunciator systems.

### BACKGROUND OF THE INVENTION

Existing annunciator lamp technology, including devices known in the art as dome lights, and further including those for medical applications, uses multiple wires from each served examination or patient room to light multiple lamps within a dome light at a location outside the door of the patient room. There may, in some applications, be one wire per lamp with a common return. This affords moderate complexity at each room, since there are likely to be four or more informational signals that can be sent from each room plus an emergency signal.

Each in-room controller in a typical prior-art system may feature a transmitting control station with a switch and a confirming light on the control station for each signal. There may further be a pull cord activating a switch for an emergency signal. Each switch closure may send power from a power supply to a corresponding lamp on the dome light assembly, then to a common return. It is understood that a similar system with two dedicated wires per switch closure could also be implemented, at further cost in wiring complexity.

Such an annunciator system may be highly reliable, but may represent a significant cost in installation materials and labor as well as complexity.

Annunciator systems in a variety of configurations are employed for rapid communication, often in spatially extended environments. Communication may be limited to a single device originating messages that are received and presented by a network of receiving devices, may involve multiple devices sending messages to a central information management station, or may involve bidirectional communication, either between a center and multiple peripherals or between multiple stations.

Annunciators may include visual (lights, text messages, icons, etc.), aural (tones, recorded spoken words, etc.), and tactile (vibration generators, etc.) indications as appropriate for an application. Computer hardware and software may be included in an otherwise noncomputational system as appropriate.

“Medical Staff Management” (MSM) or “Call for Assistance” (CFA) annunciation devices are typically wired directly to a centralized annunciation panel (CAP) located at a hospital nurse's call station or at the front desk in a doctor's office, for example. The primary purpose to which a CAP is put is alerting medical staff to a specific condition, situation, or status in a remote location such as a medical examining room. A typical condition may be a patient requiring assistance or a particular room requiring service, for example.

Current CAP technology requires labor-intensive installation and generally consumes relatively large amounts of basic materials. In particular, from each room, power and/or control wires generally must be routed to the CAP. This makes the system bulky and difficult to maintain or upgrade.

Many CAP products indicate conditions, status, or information by lighting incandescent lamps. The drawback to such lamps is that they commonly burn out after a limited working life. Therefore, a CAP may require frequent maintenance and may experience failures of individual functions.

In applications for which a need for more detailed annunciation is established after initial installation, a typical system requires physical expansion to accommodate additional wiring and added bulbs. For example, in a standard hospital application, a single white bulb, such as a common miniature incandescent lamp covered by a colorless lens, may be a sole annunciation used to alert medical staff personnel that a patient requires attention. Although such a lamp can announce an immediate need, the lamp furnishes no detail regarding the type of assistance needed. Further, in the case of an MSM application, that is, an environment such as a doctor's office, each patient typically receives a sequence of services. Here, the single lamp provides a front desk organization with no detail regarding service status. Such detail could indicate what action or service is next required in a room. For example, a patient may require a special service or may have already been seen by a nurse and be ready for a physician or physician's assistant. Requests of these types may not be adequately conveyable using a single lamp, or even a single color, on a CAP. Multiple lamp colors, which may be desirable to encourage efficient resource flow, may not be practical, as when the number of lamps is small compared to the amount of information to be transferred.

Annunciator systems can further be subject to obsolescence, so that an initially adequate system may show significant shortcomings later. For example, a prior-art annunciator system may use one or two wires from each switch in a room to a corresponding lamp in the CAP. If such a system, even a system with more than one indicator per room, requires another indication function per room, then still more wires as well as new switches may be required. For example, two lamps and an emergency (pull cord, or lanyard) signal per room for a ten-room facility might require sixty wires feeding into a CAP, plus provision for in-the-wall AC power distribution to the satellite station in each room. Pre-installing extra wires may be feasible to save follow-on labor, but may typically add to initial cost without guaranteeing future benefit.

Accordingly, it is desirable to provide an annunciator system apparatus and method whereby a multiplicity of indications is available from a series of patient services rooms to a central administration station. It is further desirable that such an apparatus and method require a minimal-complexity wiring system to support a minimal annunciator system, while permitting subsequent functional extension without installation of additional wires or upgrading of central administration station apparatus.

### SUMMARY OF THE INVENTION

The foregoing needs are met, to a great extent, by the present invention, wherein in one aspect an apparatus is provided that in some embodiments provides an annunciator system apparatus and method with multiple signals and information-rich displays. An annunciator system according to a preferred embodiment of the invention also provides a multiplicity of communication link options that can use a minimal wiring configuration to carry a large and expandable flow of information.

In accordance with one embodiment of the present invention, a monitor system is presented. The monitor system comprises a master controller, a satellite controller distal to the master controller, a bused communications interconnect that links the master controller and the satellite controller, and a message protocol configured to transmit data over the bused communications interconnect.

In accordance with another embodiment of the present invention, a monitor system is presented. The monitor system comprises means for polling a satellite controller with a master controller over a common bused communication medium. The bused communication medium is configured to be linked to a plurality of satellite controllers. The monitor system further comprises means for transmitting a response from the satellite controller in response to the polling, and means for determining a status of the satellite controller based upon the response.

In accordance with yet another embodiment of the present invention, a method for monitoring status of a multiplicity of medical services rooms from a single remote site is presented. The method comprises polling a satellite controller with a master controller over a common bused communication medium, wherein the bused communication medium is configured to be linked to a plurality of satellite controllers, transmitting a response from the satellite controller in response to the polling, and determining a status of the satellite controller based upon the response.

There have thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described, and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be used as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram showing a multiplicity of dome light control systems in accordance with one embodiment of the invention.

FIG. 2 is a diagram showing a front face and an internal face of a control station assembly in accordance with one embodiment of the invention.

FIG. 3 is a diagram showing a front face and an internal face of a multi-lamp dome light assembly in accordance with one embodiment of the invention.

FIG. 4 is a schematic diagram showing a portion of a dual use control station or dome light assembly transmitter or receiver circuit board in accordance with one embodiment of the invention.

FIG. 5 is a signal waveform diagram showing the timing and voltage features of the interunit signals within a dome light control system in accordance with one embodiment of the invention.

FIG. 6 is a representative signal waveform showing a signal from a representative control station assembly to a representative dome light.

FIG. 7 is a block diagram illustrating major elements of a system according to a preferred embodiment of the invention.

FIG. 8 is a view of a CAP display according to a preferred embodiment of the invention.

FIG. 9 is a schematic diagram of a hardware circuit board compatible with the block diagram of FIG. 1.

FIG. 10 is a flowchart illustrating steps that may be followed in operating a system realized in accordance with one embodiment of the method.

### DETAILED DESCRIPTION OF THE PREFERRED EMBODIMENT

Established annunciator technology for environments such as doctors' offices, clinics, and primary care facilities may have provisions for identifying the status of individual patient rooms, such as by the presence of file folders in a basket outside the door. More technologically elaborate solutions may include, for example, a single lamp outside a patient room controlled by a switch inside the room. All such basic solutions have limited utility and none provides emergency support. More elaborate lamp-based indicator systems, to include those with two or more lamps in a dome light assembly, can include complex control wiring, possibly requiring one or more wires per lamp. Such systems may lack the ability to support enhancements without altering or adding wiring.

An exemplary embodiment of the present invention may include at least one lamp in a dome light assembly that can be affixed outside a patient's room in a medical clinic, for example, which dome light assembly can be controlled from a control station inside the same room. The dome light assembly may receive both power and control signals on a single wire pair from the control station. It may be desirable for the single wire pair that provides power and control to be implemented using multiplexed control signals, contained, for example, in a serial digital command string. This is particularly true for feature-rich dome light assemblies. Some such assemblies can include more than one lamp. In some, the individual display elements within the dome light can be provided with filters, different color light emitting diodes (LEDs), or equivalent features to permit emission in different colors. In some, the lamp can emit using heightened-alert features such as flashing. In some, the dome light assembly can include capability for emitting sound.

It should be noted that terms such as controller, processor, microprocessor, personal computer, and the like are used substantially interchangeably herein, with qualifying terms added to indicate functional and location distinctions. A digital electronic device that can read and write data from and to external and/or internal device interfaces and storage, and which executes a predetermined or modifiable instruction sequence that may include making decisions based on input data or events may be assigned any of a multiplicity of names, but be substantially interchangeable in practice. A typical controller device may include internal analog-to-digital conversion (ADC) capability, internal instruction and data storage, and ability to access external communication devices, for example. Another controller device may have no internal storage and no internal ADC but instead have built-in communications functions, for example, yet be essentially equally suitable for embodiments of the inventive apparatus and method described herein.

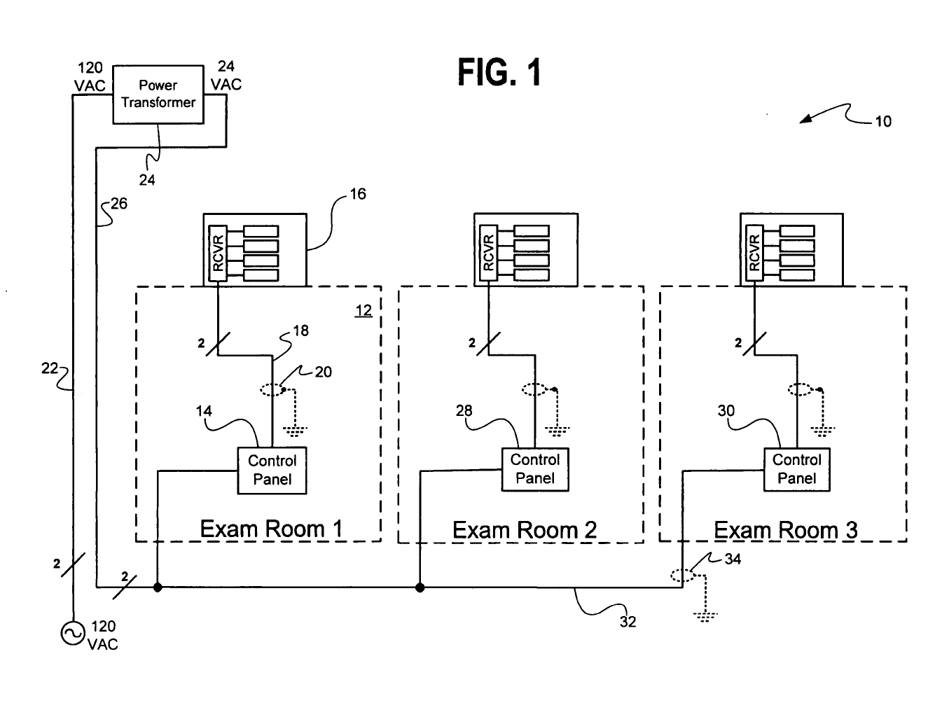

Turning now to the figures, wherein like elements are denoted by like reference numerals throughout, FIG. 1 is a diagram of an exemplary dome light control system 10 in accordance with one embodiment of the present invention. The dome light control system 10 in FIG. 1 shows, located inside a patient's room 12, a control station 14 and connected to a dome light assembly 16 located outside the patient's room 12. The control station 14 is connected to the dome light assembly 16 by a two-wire cable 18 that may preferably be equipped with a shield 20.

Power to the control station 14 may originate in utility wiring 22, from which it may be fed from a central transformer 24 by low-voltage alternating-current wiring 26 serving preferably a multiplicity of control stations 14, 28 and 30 through power distribution wiring 32. Shielding 34 on all power distribution wiring 32 may likewise be desirable.

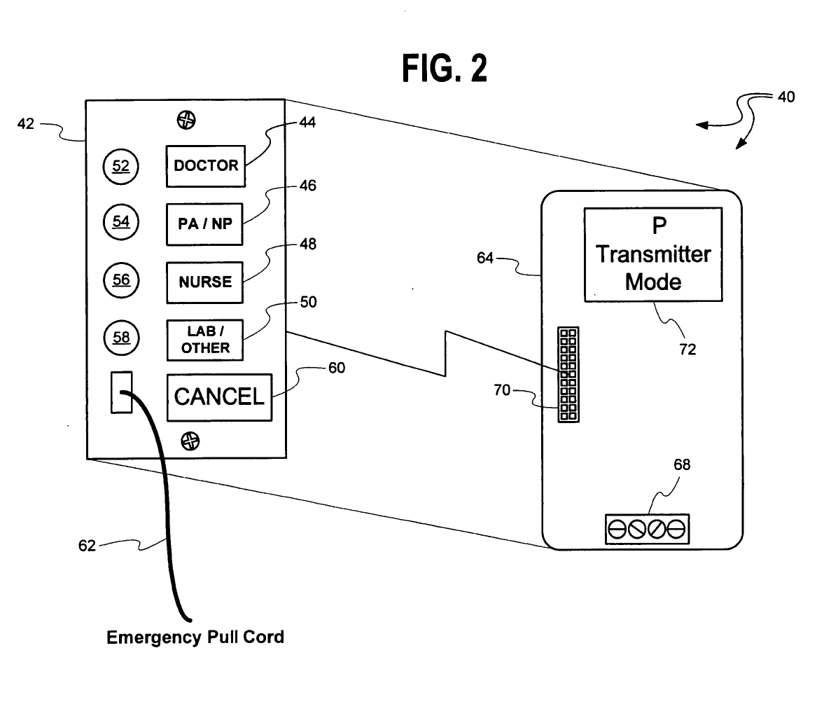

The control station 40 in the preferred embodiment, shown in greater detail in FIG. 2, includes a user interface 42 such as a series of pushbuttons 44-50, each of which is associated with a status display lamp 52-58. Such a control station 40 can firther provide a single cancellation button 60 permitting all requests to be cleared at once and a lanyard-type emergency pull switch 62 that can be used with less requirement for operator precision. Alternate implementations can use lighted pushbuttons 44-50 and dispense with the provision of separate lamps 52-58. Each pushbutton 44-50 can be further enhanced, such as by allowing sequential presses to cycle button function through normal (constant on), flashing (such as 50% duty cycle at one on-off cycle per second or another desirable rate), and off, which capability may optionally allow omission of the cancellation button 60.

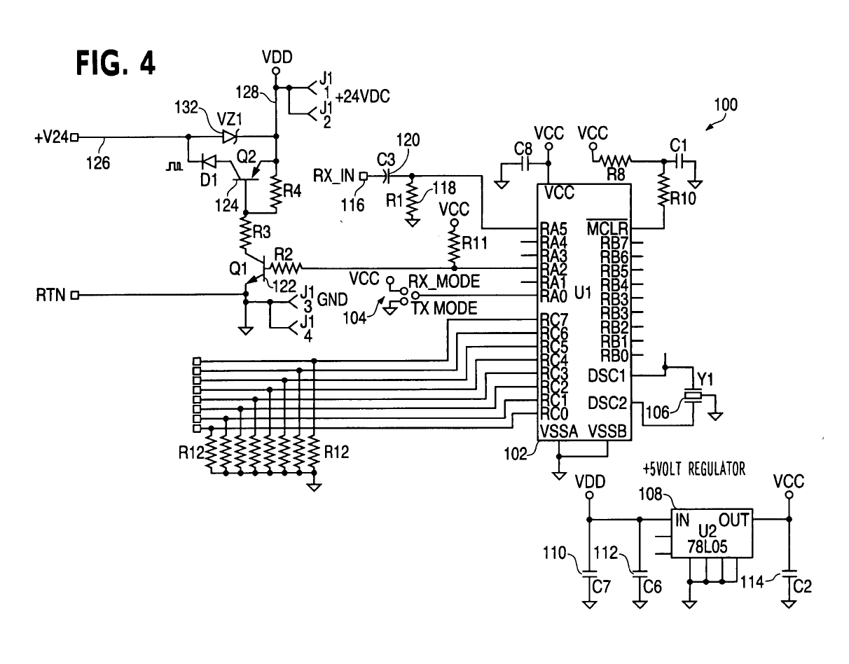

An internal face of the control station 40 also is shown in FIG. 2, wherein a circuit board 64 can be wired to incoming low-voltage AC and outgoing command power/signal at a terminal block or connector 68. The circuit board can establish a multiconductor interface to the user interface 42 of the control station 40 by a keypad connector 70. Among the circuit elements present on the circuit board 64 can be a transmitter microprocessor integrated circuit (IC) 72, the functionality of which is discussed below under FIG. 4.

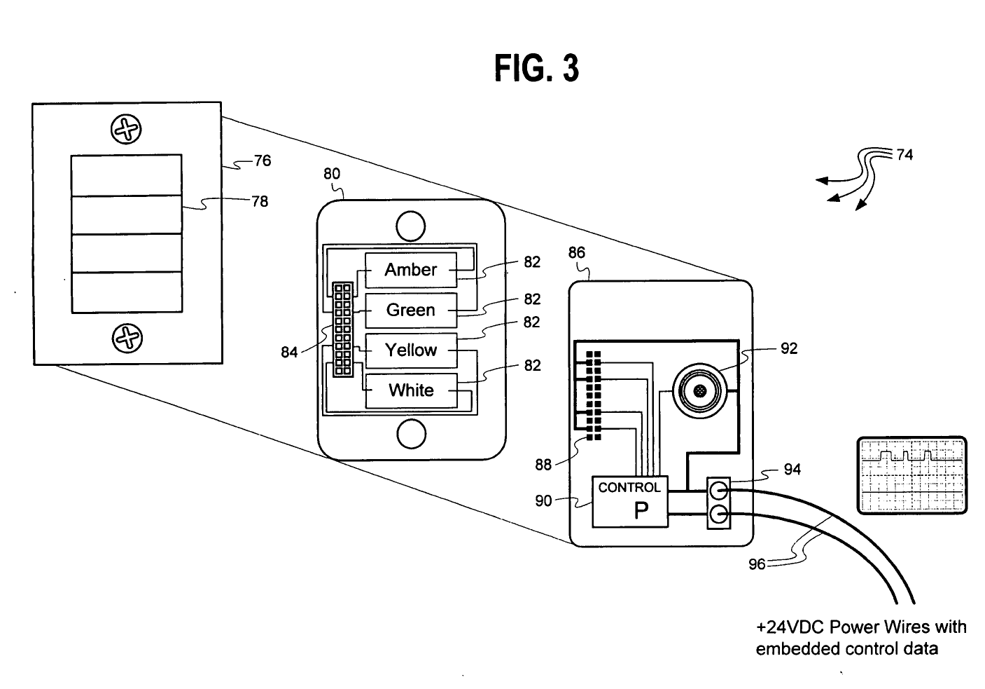

FIG. 3 shows a dome light 74. Like the control station 40, the dome light 74 includes an outer escutcheon plate 76, which may be equipped with a simple clear or fogged lens, a multiplicity of tinted lens segments, or an equivalent 78. Behind the escutcheon plate can be a circuit board 80 on which can be mounted a multiplicity of lamps such as light-emitting diode (LED) arrays 82. Such LED arrays 82 may provide sufficient brightness, power efficiency, and longevity to be preferable to previous technologies, such as neon and incandescent bulbs, which may be desirable in some applications. Alternative display technologies such as backlit liquid crystal displays (LCD) may also meet requirements for brightness, long life, and low power consumption. A stacking connector 84 is shown as an interface to a second circuit board 86. Behind the display carrier circuit board 80 in the exemplary dome light 74 is shown the second circuit board 86, using mating stacking connector 88, that can carry a receiver microprocessor 90 to receive serial digital signals transmitted from the control station 40 and interpret them as commands to light the displays 82 and/or to activate a sound generator 92. A dome light connector or terminal block 94 can provide interconnect to the pair of wires 96 feeding power and control to the dome light 74 from the control station 40.

FIG. 4 shows an exemplary circuit board communication section 100 in schematic form. This communication section 100 includes a microprocessor IC 102 that can be programmed as a transmitter or receiver using a direction jumper 104 that straps a control pin high or low. The microprocessor IC 102 includes a clock oscillator function that may be adequately well controlled with an RC network (not shown) or may preferably employ a crystal 106 to ensure that the sample rates will be tightly controlled. The exemplary microprocessor IC 102 may require a tightly regulated DC power supply at 3.3 volts, 5 volts, or another setting; a regulator 108 with associated decoupling and filter capacitors 110-114 can be included to provide the required power. Such a power supply 108 may be linear or switching; minimum complexity may recommend linear, while minimum power consumption may find a switching regulator preferable, some of which latter devices require inductors (not shown) to provide high efficiency and low parasitic noise.

A control station 40 may be powered, for example, from bused, intrinsically safe power, such as the 24-volt transformer-isolated alternating-current power supplied from a central power supply 24 and distributed by low-voltage wiring 26 as shown in FIG. 1. Such power can be rectified and filtered with a diode-capacitor network including a bridge rectifier, for example (not shown), to provide unregulated direct current at roughly 24 volts, shown arriving at the exemplary transmitter section of the control station 40 on the +24 VDC input pin 128. This power can be adequate to drive the circuit board shown in part in schematic form in FIG. 4, where the circuit board is jumpered to function as a transmitter, as well as to provide the power needed by a dome light assembly 74, which uses the same circuit board of FIG. 4 jumpered as a receiver and powered via the signal input pin 116. In the exemplary system, both output power and command signals to the dome light assembly 80 are provided on the 18-volt output pin 126, with the power dropped down from the unregulated 24-volt power using a zener diode 132 to provide signal swing for the command signals.

Input signals to a microprocessor 102 configured as a receiver (jumper 104 set high by a jumper between pins 1 and 2 thereof) may arrive on an input line 116, which line can be pulled low by a weak resistor 118 and permitted to swing high during positive-going signals by a coupling capacitor 120. Output signals from a microprocessor 102 configured as a transmitter (jumper 104 set low by a jumper between pins 2 and 3 thereof) can be configured to drive bipolar transistors 122 and 124 to force output line 126 high during each logic-1 interval, which intervals are determined by the internal processing of the transmitter microprocessor 102 and output from pin 4, named RA2, thereof. Output line 126 is pulled low by load current in the receiver microprocessor circuit driven by the transmitter-configured circuit, including quiescent current in the regulator IC of the dome light assembly and current drawn by any lamps illuminated in the control station 40 panel and the dome light assembly 80.

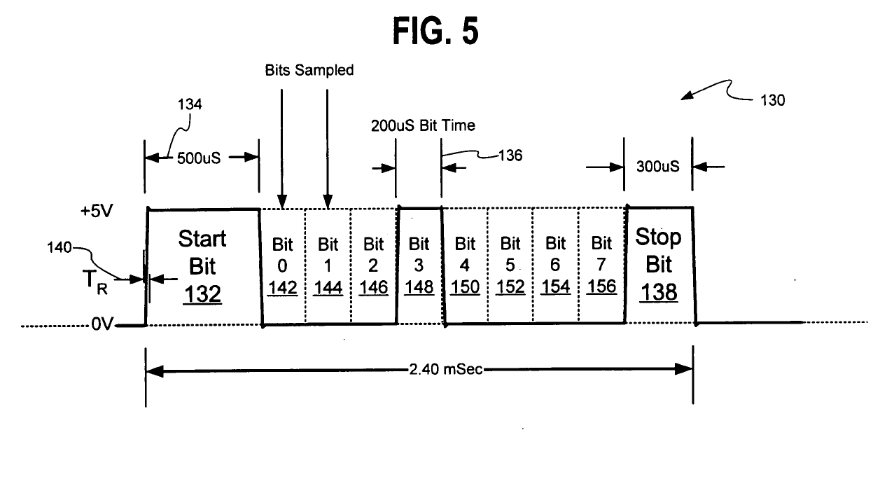

FIG. 5 shows a representative waveform 130, as generated within the transmitter circuit board and substantially as received by the receiver circuit board. This complementary metal-oxide semiconductor (CMOS) digital logic compatible signal can be sensed using edge or level triggering within the microprocessor IC 102 of a receiver circuit board according to FIG. 4 to start an internal timer that can be used to confirm that the start bit 132 has duration between suitable limits to confirm normal operation. In the exemplary system, a start bit duration of 500 microseconds is shown as nominal. A receiver circuit board microprocessor IC 102 that can operate significantly faster than this rate can sample the signal several times during the course of the start bit 132, verifying that the pulse duration 134 is correct within an established range, and thus confirming the identity of the pulse. Many other synchronizing schemes exist that can accomplish such start bit confirmation.

The signal timing indicated in the exemplary embodiment, shown in FIG. 5, is 500 microseconds for the start bit 132, 200 microseconds per data bit 136, and 300 microseconds for the stop bit 138. This signal timing is effective and adequate, but is not uniquely required for the invention. Transmitted signal rise time 140 need only be rapid enough to trigger an edge-triggered timer (not shown), a function located within the microprocessor IC 102 of FIG. 4, a speed requirement that can be obviated by the use of a level triggered timer (not shown) within the microprocessor IC 102 of FIG. 4. Similarly, successive data bits 142-156 may be of any known timing provided they are of sufficient duration to allow each bit to be stable in a state before sampling.

Once the start bit 132 has established timing, successive samples can be taken at the center of each successive bit time. In the exemplary waveform, which transmits the least significant bit (LSB) 142 first, only Bit 3 148 is active. This could correspond to a doctor call lamp being steadily lit, for example. Similarly, setting Bit 4 150 could correspond to an emergency, Bit 5 152 to activation of the sound generator, Bit 6 154 to flash all active lights, and Bit 7 156 to flash sequentially instead of simultaneously any lights enabled to flash by Bit 6 154.

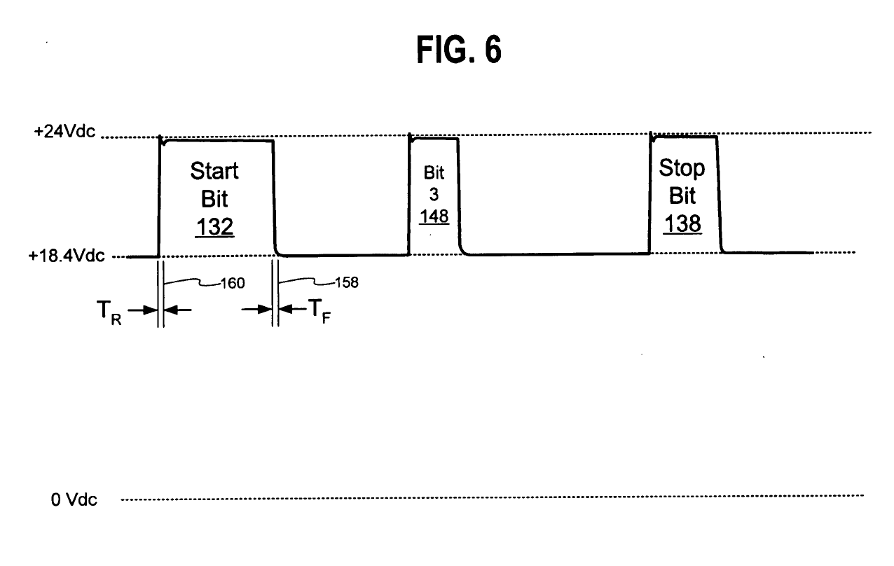

FIG. 6 shows the representative waveform of FIG. 5 as combined with DC receiver board power to appear on the output line 126 of FIG. 4. Timing and drive properties are substantially identical to those of the internal signals shown in FIG. 5, with the reduced pulldown capability of the exemplary open-collector configuration having little effect on falling-edge timing 158 and the increased drive of the exemplary bipolar transistor 124 having similarly slight net effect on rising-edge timing 160.

Other message formats are possible, such as the use of a longer command word, which command word could include assignment of more than the previously mentioned two bits, thereby providing for more state options for each lamp. Another option, transmitting, for example, a single message per lamp, could include a lamp number and a command code. Another option could leave the transmitter with the burden of keeping track of display functions, and could require the transmitter to send a new command word for each state change in the dome light. Thus, to emulate the above operation, a flashing doctor call would require a new command to be sent each half-second —first on, then, after a half-second wait, off-instead of sending a flashing-doctor-call command once.

Other electronic line drivers and receivers and their associated microprocessor ICs may be usable in place of the devices shown in FIG. 4. The exemplary configuration is single-ended, which can be adequate for short to moderate line lengths, while alternatives include differential drivers, which can be superior over longer lines.

Fiber optic communication may also be feasible, although the properties commonly viewed as making fiber desirable may be of limited benefit in the exemplary system. For example, fibers can be used to transmit the commands described above, and have the particular advantage of being effectively free of risk of causing interference in other medical apparatus in a room. Such approaches typically require separate power connections. Using another approach, light from high-brightness signal sources such as laser diodes, sent through low-loss fibers used as light pipes, can directly illuminate diffusers, so that neither electrical power nor active parts are required at the dome light unit.

Applications of the present invention can include support of multiple-station ward areas with multiple entrance doors. For such configurations, central timekeeping—that is, a single master clock to which all stations would be resynchronized periodically—may be preferable. Such synchronization, with microprocessor IC 102 transmitters programmed to start their respective transmissions only at specific intervals, may require bit transmit times to be uniform after a button is pressed at any station. Using the open-collector configuration of the output transistor 124 in FIG. 5, this approach may permit output from multiple transmitters on a single shared line. Multiple receivers operated in parallel can be used in such as system, with the number of receivers limited only by the available power.

In a preferred embodiment, the present invention provides a master controller located at a central station, a satellite controller located in each of a multiplicity of remote rooms, a communications interconnection system such as a wiring network, a power distribution provision, and a communications signal protocol. Each master controller and each satellite controller includes a stored-program processor, along with volatile and nonvolatile memory for use with the controller and for data storage.

In the preferred embodiment, the satellite controllers are controlled by one or more sensor inputs, where such sensors may be implemented with electromechanical circuit closures such as isolated switches, coincidence of row-and-column activation as in a keypad matrix, detection of a physical property such as a capacitance change or surface-acoustical-wave reverberation due to finger pressure on a touch sensor, voice recognition, or other embodiment. The master controller detects electronic signals sent by the satellite controllers according to the protocol, and causes actuation of one or more indicators such as lamps, icons, and/or text messages to be displayed in response to the signals received. Indicator devices, including display elements, audible signals, and other functions of the master controller, may be controlled in part by the content of the signals from the satellite controllers, in part by control inputs located at the master controller, and in part from commands transmitted from a central controller to which the master controller reports.

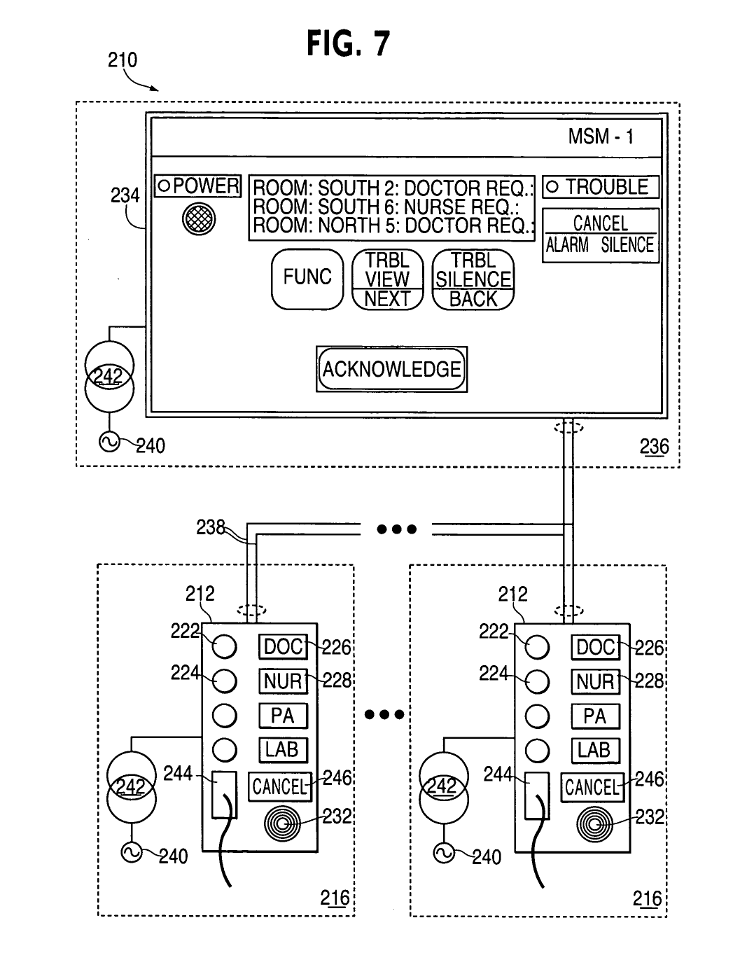

FIG. 7 illustrates a preferred embodiment of the present inventive apparatus and method in block diagram form. An MSM control system 210 includes at least one satellite controller 212 located at a remote site such as a doctor's office examination room 216. The satellite controller 212 includes a first pushbutton switch 222, a second pushbutton switch 224, a first indicator lamp 226, a second indicator lamp 228, a lanyard switch 244, and a sound port 232.

In the preferred embodiment, the satellite controller 212 and a master controller 234 which is located at a medical staff management station 236 are interconnected for example by wiring such as shielded cables 238. The wiring system in the preferred embodiment can be made up from any number of wired connections, such as an impedance-controlled twisted pair multi-drop bus, addressed in more detail below.

FIG. 7 further shows that electrical power for the system 210 can be provided from premises distributed AC power 240, which can be stepped down to a preferred voltage with transformers 242, and which may include voltage rectification and/or regulation functions in some embodiments. The embodiment in FIG. 7 shows independent power feed to the master controller 234 and to the satellite controllers 212 using premises wiring to distribute power and using local power conversion at each satellite controller 212. For some applications, alternative power provision embodiments may be preferable, such as transforming the premises power to a lower voltage at the master controller 234 and distributing either AC or DC at low voltage over the interconnecting signal wiring 238 to provide power to some or all satellite controllers 212.

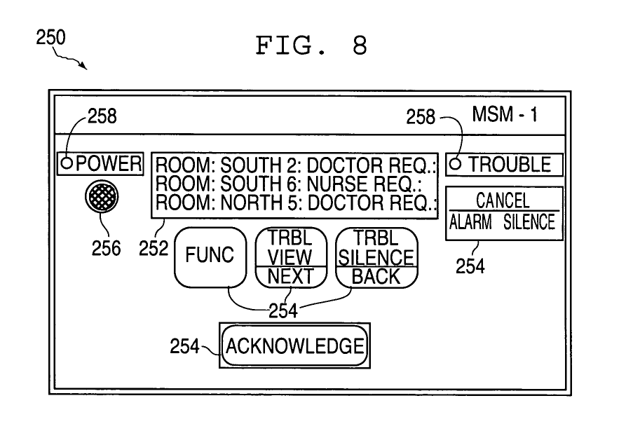

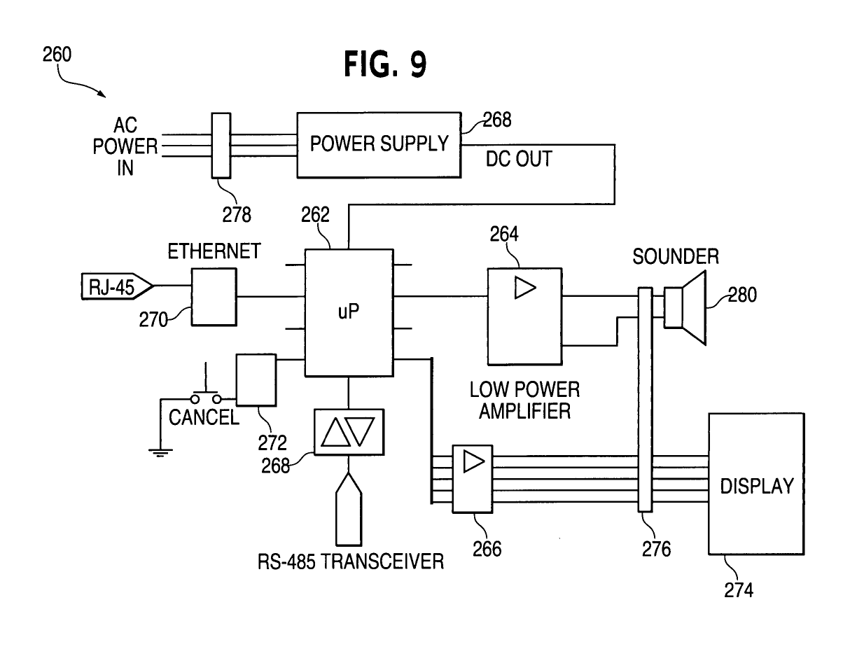

FIG. 8 shows the master controller display panel 250 of FIG. 7 in greater detail. In the preferred embodiment, the master controller display panel 250 includes at least one indicator 252 that presents information regarding each of the satellite controllers 212, as well as switches 254 for controlling selected functions of the master controller (260 in FIG. 9). In addition to indicator 252 and switches 254, the display panel 250 may include a sound generating device 256.

It may be observed that the panel 250 shown is one of many types possible. The 3-line text display 252 presents data in one of many possible formats. Discrete pushbutton switches 254 and LED indicator lamps 258 are preferably included in the embodiment. An alternate embodiment can represent the entire display panel 250 of FIG. 8 by a graphic screen, for example. Other embodiments may include a graphic screen representing a floor plan with rooms, corridors, and satellite controller 212 locations in pictorial or icon form, for example, and with touchscreen capability in place of discrete buttons or switches.

FIG. 9 shows in schematic form the circuit used for a satellite controller 212 or a master controller 236. It may be observed that the similarity of the basic circuit functions and devices may permit identical circuit boards to be used for both devices. Nonetheless, for some applications, it may be preferable to use circuit boards that are different from each other.

The schematic diagram 260 of FIG. 9 has a stored-program processor IC 262, an IC sound driver 264, an IC indicator driver 266, an IC transceiver 268 for RS-485, an IC Ethernet transceiver 270, a switch closure detection IC 272, and a power converter 268. Protective devices such as fuses, capacitors, transient suppressors, and series resistors, none of which are active in normal operation, and all of which are omitted from this schematic to more clearly present the novel features of the invention, can be used to protect the master and satellite controllers from electrical noise of severity up to near-miss lightning strikes.

The IC driver 264 for the sounder 280 may in some embodiments be a self-contained fixed tone generator. In other embodiments, a tone generator may store one or more downloaded tone waveforms that it then reproduces. In still other embodiments, the tone generator may amplify a tone injected into it, which tone in such embodiments might be created within the processor 262 from a lookup table, might be calculated from a mathematical model in software, or might be a recording or a voice message from another device, for example. For any tone generation method, of which the aforementioned are examples, the output in the embodiment shown is fed to the front panel interface connector 276. Assembling the master controller 246 connects the sounder 280 to the front panel interface connector 276. In still other embodiments, the sounder 280 may be mounted on the master controller 246 circuit board, with a grille or other port on the front panel serving to pass the sound to the outside.

The selection of an IC driver device 266 for the front panel visual display is determined by the details of the front panel display in each embodiment. For example, an embodiment could use incandescent lamps to show status of each remote station 212, in which case a lamp-compatible driver IC 266 with a separate output port for each lamp could be preferred. In another embodiment, light-emitting diodes could be used as direct replacements for incandescent lamps, in which case a LED-compatible driver IC 266 using an organization similar to that of the incandescent-compatible driver might be preferred. In still another embodiment, where a liquid crystal display is used as the display device 274, yet another display interface IC 266 could be required, in addition to which a backlight power supply (not shown) could be needed. Still other display devices 274 are self-contained, that is, they include storage registers for display data. For compatibility with such displays, a digital data interface, possibly including external buffers, could suffice in lieu of power drivers. A circuit board layout compatible with multiple display styles may be preferable.

Communication between patients'rooms (216 in FIG. 7) and a nurse's station (236 in FIG. 7) has been described herein as using a satellite controller 212 at each patient's room and a master controller 234 at the nurse's station 236. In the preferred embodiment, both the master 234 and satellite 212 controllers include transceivers 268, with the nurse's station master controller 234 transmitting polling messages to each patient's room satellite controller 212 in sequence, and with each patient's room satellite controller 212 replying to a valid polling message with a status message. Such an arrangement permits a communication environment free of signal collisions, which may be preferable in some embodiments.

An example of a communications protocol that can use such a communications arrangement is Electronic Industry Association (EIA) Recommended Standard (RS)-485. RS-485 is intended to use a differential signal and is compatible with using a single master controller 234 and a multiplicity of satellite controllers 212 sharing a single bused wire pair. RS-485 calls for all satellite controllers 212 to wait until polled, so the limit on system size is largely determined by the data rate chosen, the message length, and the desired system refresh rate. For example, if a polling system has an assigned bit rate of 19.2 Kbps, a system refresh rate of ½ second, a quantity of satellite controllers 212 in the system limited to 32, and incoming and outgoing messages of equal length, then a message length of about 150 bits (more than 18 bytes) is possible.

The preferred embodiment also shows an Ethernet® port 270, which may be used for communication between a master controller 260 and a supervisory computer (not shown), may be used to permit groups of satellite controllers 212 to be clustered, or may be used in lieu of the RS-485 bus. It may be observed that typical applications of Ethernet use from two to four twisted pairs of wires throughout a system, as well as using a switching device that includes a dedicated multiple pair cable per Ethernet port. While a hardware-intensive approach of this kind may be less desirable in general, the materials for an Ethernet-based configuration are in common use, and thus may be preferable for some applications. Ethernet may also allow a high data rate, which may have additional benefits.

In some embodiments, an individual master 260 may support a floor or a wing of a hospital, for example, as one of multiple masters 234 reporting to a central office of the hospital. Communication between the multiple masters 234 and the central office, which may preferably use an Ethernet configuration, may be polled, or, according to system architecture preference, may use asynchronous message transmission by each of the masters 260.

Use of a switch closure detection IC 272 may be preferable in order to enhance system robustness. However, in a system 210 with good noise protection, such as one with a processor IC 262 featuring high intrinsic immunity to static discharge or with a housing that readily dissipates charge and is grounded, a separate switch closure detection IC 272 may be redundant.

A bidirectional communications connector 268 may serve a single shielded pair in the case of a system with one RS-485 link only, or may support more than one RS-485 and/or Ethernet or another communication protocol, as preferred. RS-485 and similar protocols may likewise be implemented using nonshielded wire pairs, coaxial lines, and other electrical interconnect technologies, as well as fiber optic data lines.

A front panel interface connector 276 requires enough connections to support the display method selected for an embodiment, as well as to support as many switch closures as may be required for an embodiment. The connection technology chosen for an embodiment, for example pin-in-socket, ribbon-in-slot, ball grid array, or another, may be a matter of individual preference. Human interface event detection may use individual switches, crosspoint switch matrices, polling, or other methods. Sound and other functions may be supported on the board or through the front panel interface connector 276. Alternative embodiments may avoid using a separate connector by various technical alternatives, such as direct wiring of a cable to the circuit board, direct mounting of display and switch closure devices on the circuit board, and the like. In some such embodiments, some or all passive devices (resistors, capacitors, etc.) and active devices (ICs and other semiconductor devices) may preferably be mounted on a back surface of the circuit board.

Use of a power connector 278 may be preferable for many master controller 260 embodiments. Power may be fed directly from premises wiring (nominally 120 volts AC in the U.S. and some other countries, 240 volts AC in most others) to a circuit board, may be isolated and/or reduced in voltage with an external transformer (242 in FIG. 7), and may be externally rectified and/or regulated and supplied at the particular DC voltages required for operation. Power for use in the satellite controllers 212 may in some embodiments be fed to the satellite controllers 212 on the RS-485 data bus. Individual satellite controllers 212 may be powered using separate power connectors in other embodiments.

Interconnection technologies other than implementation of RS-485 using a shielded twisted pair bus may likewise be preferred for other embodiments, such as embodiments for use in applications wherein a user has a comparable but possibly incompatible wiring system already in place. In such applications, a system upgrade method capable of reusing existing wires may be preferable. A preexisting system with unshielded direct wiring from each patient's room back to a master station, for example, may be reconfigurable as parallel pairs branching out from the master with acceptable noise and speed performance.

Wireless and pseudo-wireless systems may be preferred in alternate embodiments. Typical “true” wireless systems may employ bidirectional radios similar to those used in wireless Ethernet, described in Institute of Electrical and Electronics Engineers (IEEE) standard 802.11. Pseudo-wireless systems may couple radio-frequency AC signals into and out of premises electrical power distribution wiring within a facility. In applications in which such are strategies realistic, wireless interconnection may be preferable.

Housing for a preferred embodiment of the inventive apparatus 210 described herein may be one of a desktop enclosure, a flush mount style wall panel, a surface mount style wall panel, a rack mount style enclosure, and any other workable combination of electronic device enclosure, visual display, multiple switch closure interface, electrical power interface, and wiring interconnection. An acoustic emitter and/or detector, such as a speaker and/or a microphone, may be desirable elements within each such configuration.

The preferred embodiment, through use of a bused interconnect 238, achieves a low wire count, in exchange for which the wiring functions as a comparatively effective transmission line.

Polling is a method whereby a central functional unit (master controller 234 in FIG. 7) can acquire data from a multiplicity of remote functional units (satellite controller 212 in FIG. 7) without risk of generating timing conflicts. A typical application of polling uses a master controller 234 and satellite controllers 212 that send and receive messages using a common protocol and compatible message properties such as data bit rates. In a typical polling application, a master controller 234 sends out a message addressed to a single satellite controller 212, which is programmed to respond with a reply message. The master controller 234 then continues to send out messages until all satellite controllers 212 have been addressed and have responded, which completes one round of polling. Polling implementations vary greatly in their strategies for searching for new satellite controllers 212, in the number of repetitions to be directed to a single satellite controller 212 if a reply message is defective, in the frequency with which rounds of polling are performed, and in numerous other details.

The preferred poll/response embodiment disclosed herein will be referred to as master/satellite. The satellite controllers 212 may preferably be configured to respond only when the master controller 234 polls them.

The master controller 234 can preferably include a microprocessor 262 that can detect valid addresses from satellite controllers 212 and associated apparatus, representing, for example, patient rooms 214 on an RS-485 network, and can configure an internal active mapping that can then be stored in flash ROM that is external or internal to the master controller microprocessor 262.

Flash ROM is an electronic storage medium that can retain data such as the above mapping indefinitely without a source of external power until flash ROM content is reconfigured by a user. By using flash ROM, satellite controllers 212 may be added immediately or later in order to accommodate system expansion. Flash ROM also permits a previous configuration to be retained despite repeated removal and application of power.

Satellite controller addresses are ordinarily assigned to satellite controllers 212 in individual rooms, although additional addressable controllers in a network may function as security and safety interfaces, hallway speakers, pagers, and other devices that are not room satellite controllers 212.

A network in a preferred embodiment can support up to 32 satellite controller addresses, which corresponds to the transmitting load limit of a system designed to conform to the baseline specification for RS-485. More addresses—rooms and other facilities—an be added beyond 32 by a variety of methods, including the addition of one or more RS-485 repeaters. An RS-485 repeater may be a bidirectional signal booster that occupies one unit load, which would require that a primary-network device be deleted from a fully-compliant RS-485 based network for every added repeater. In that case, a fully loaded system with a master and three repeaters in a star configuration (a first string of satellite controllers 212 in any branching arrangement of twisted pair wires with impedance adjusting terminations at branch points, and with three of the satellites omitted in favor of repeaters, each of which drives its own fanout of 32 satellites) could support as many as 32×3+(32−3)=125 rooms or equivalent loads. Variations on RS-485 can also accept more satellite controllers 212 per master controller 234, for example by increasing line impedance and lowering the load current each satellite controller 212 is allowed to draw.

The master controller 234 in the preferred embodiment is configured to poll each room, detecting any status changes that may have occurred since the last polling. Status changes will normally correspond to switch activations in a patient's room that have not been responded to previously. The master controller 234 may preferably compare the last recorded status to the current message content for each room. If the two differ, the master controller can update its room status register and activate the appropriate lamp/LED/LCD display element to match the room's status. If no active status is reported, the master controller can deactivate the lamp/LED/LCD display element for the polled room.

It may be observed that, in a typical MSM or CFA system, the likelihood of a switch activation event in any polling period may be relatively low. As a result, a system in which satellite controllers 212 record and report switch activation and release events and so inform the master controller 234 during each polling cycle may follow up such satellite controller 212 reports during a first polling period by having the master controller 234 asynchronously send an acknowledgement that allows a state machine within the satellite controller 212 to advance from a “sensed but not yet acknowledged” state to a “sensed and acknowledged” state. In the latter state, the satellite controller 212 can activate a local indicator corresponding to the switch activation or release, can return to a quiescent state, or can respond in another appropriate way. For example, if push buttons and indicator lights are present on the satellite control panel, then pressing a specific push button, even momentarily, can set a pair of data elements within the satellite controller 212, one recording the button press and the other the release. During the next polling event, the satellite controller 212 can report the button push, or, if the system is so configured, both events. Either immediately or after completing the polling sequence, the master controller 234 can command the satellite controller 212 to turn on the associated indicator light ( 226 or 228 in FIG. 7), and the satellite controller 212 can confirm that this has taken place.

When a lanyard switch 244 is activated in a patient's room, the master controller may illuminate the “emergency” status and override any current status for the respective room. An “emergency” status may preferably be assigned the highest priority of all status indicator types. The master controller 234 may have the capability to activate a sounder (280 in FIG. 9) when an “emergency” status is activated. The operator at the master controller 234 may further have the ability to mute the sounder 280. In the mute mode, the display element corresponding to the satellite controller 212 announcing an emergency may preferably remain energized until the status is reset from the point of origin—that is, the satellite controller 212 at which the lanyard 244 is located. Any status indication, including “emergency,” can be cleared from the master controller momentarily, but actual status reset can only occur in the patient's room by activating a “CANCEL” function (246 in FIG. 7). This fail-safe design may prevent staff personnel from mistakenly clearing an active room request.

For a preferred master controller embodiment, a message containing 11 bytes and limited to ASCII characters may be employed. It is to be understood that alternative message formats may be preferred in some embodiments. The following is a description of the poll message:

A typical polling-based operational scheme compatible with a preferred embodiment of the invention could take the form of a data request message with the form—
<STX><U><A><F1><F2><F3><F4><F5><ETX><ck1><ck2>
. . . where <STX> is a single byte start-of-text message, <U><A> is a two byte unit address (00-FF), while <F1>, <F2>, <F3>, <F4>, and <F5> is single byte data fields, <ETX> is a single byte end-of-text field, and <ck1> and <ck2> is a two byte checksum.

Regarding timing for this example, bit time at 19.2 Kbits/sec is just over 52 microseconds per bit. With 11 bytes transmitted from the master controller 234, the total transmission time is roughly ((11 bytes ×8 bits/byte)×52 microseconds per bit =4.58 msec. Response time of the satellite controller 212 is likewise 4.58 msec because it also contains 11 bytes. Total time for a poll and response is 4.58 msec×2=9.16 msec. For an entire 32 unit network, then, 32×9.16 msec=293 msec. At this speed, satellite controller 212 switch closures can be detected with a high level of reliability. If a retry is attempted on the next poll, the response time doubles (293 msec×2=586 msec). This provides a repetition rate faster than one polling cycle per second.

As an example, a master controller polling a room could send out the following message having a series of ASCII characters to a room in which a satellite controller 212 that has been assigned the address 02 is located:
<STX>02 4 3 0 0 0<ETX>5C

In the above example, the master controller polling address is 02, the F1 and F2 fields contain the command 4 3, which has been designated as the poll command, and fields F3, F4, and F5 are padded with zeroes as they are not needed in the poll command. The message terminates with <ETX> and is then followed by a two-byte block checksum.

In this example, the block checksum is calculated to be 5C as follows. Each byte is converted to its hexadecimal value, after which a summation proceeds, starting at the <U> byte and ending with the <ETX> character. <STX> has a hexadecimal weight of 02h and the <ETX> character has a weight of 03h. Dropping the high byte in the resultant leaves the lower two bytes, with a value of 5C (hex).

When the target satellite controller 212 receives the poll message, it calculates the block checksum and compares it to what was sent from the master controller 234. If the two checksum values match, the message is presumed to be error free and ready for processing. However, if the checksums differ, the satellite controller 212 can transmit a <NAK> character, for example, to indicate that a corrupt message was received. In response, the master controller 234 can retry the transmission, for example up to a set number of times. If the message continues to arrive corrupted, the master controller 234 can post a communications fault indication on its network. The fault indication can show which satellite controller 212 address appears to be experiencing trouble. The master controller 234 panel trouble display and sound generator 280 can be set to annunciate. A provision for muting the sound generator 280 after acknowledgement can be included in system design.

This is a typical method for generating a robust checksum for raising data transmission confidence. Other methods can provide lesser or greater levels of confidence, such as parity bits that provide rudimentary verification, data encryption routines that can identify many specific single and multiple bit faults in short messages and can allow some troubleshooting of a data path, and error correcting codes that can in some configurations allow operation in an electrically noisy environment.

The following 11 byte message can be a satellite controller's response to the polling message above:
<STX>02 4 3 0 1 0<ETX>5D

The <STX> <U> <A> <4> <3> can be an echo what was received by the satellite controller 212. The F3, F4, and F5 fields can be populated with the unit's current status. See Table A for a typical status indication field description.

TABLE A
Status Indication Fields

| Status | F3 | F4 | F5 |
|---|---|---|---|
| No Action Req./Cancel | 0 | 0 | 0 |
| Doctor Requested | 0 | 0 | 1 |
| PA/NP Requested | 0 | 1 | 0 |
| Nurse Requested | 0 | 1 | 1 |
| Lab/Other Requested | 1 | 0 | 0 |
| Reserved | 1 | 0 | 1 |
| Reserved | 1 | 1 | 0 |
| Emergency | 1 | 1 | 1 |

The decoding and verification process for the returned message may be essentially symmetrical with that for the polling message. Checksum errors in a returned message may result in the master controller's retransmission of a data request message.

System initialization after application of power may include a configuration check in which the master controller transmits every possible address, requesting switch status of each address. Barring failures, an exhaustive search may be expected to detect that all of the addresses previously in use (and stored in flash ROM) respond with an indication that no switches are activated. Many system malfunctions may be detected in this way, since depowered or misprogrammed satellite controllers 212 may fail to respond or may respond incorrectly, and stuck switches, or their equivalents in satellite controllers implemented without mechanical switch devices, can be expected to show up as active switches where none such are expected. Such a test can also be activated by selection from a functional menu if implementation of such features in a particular embodiment is desired.

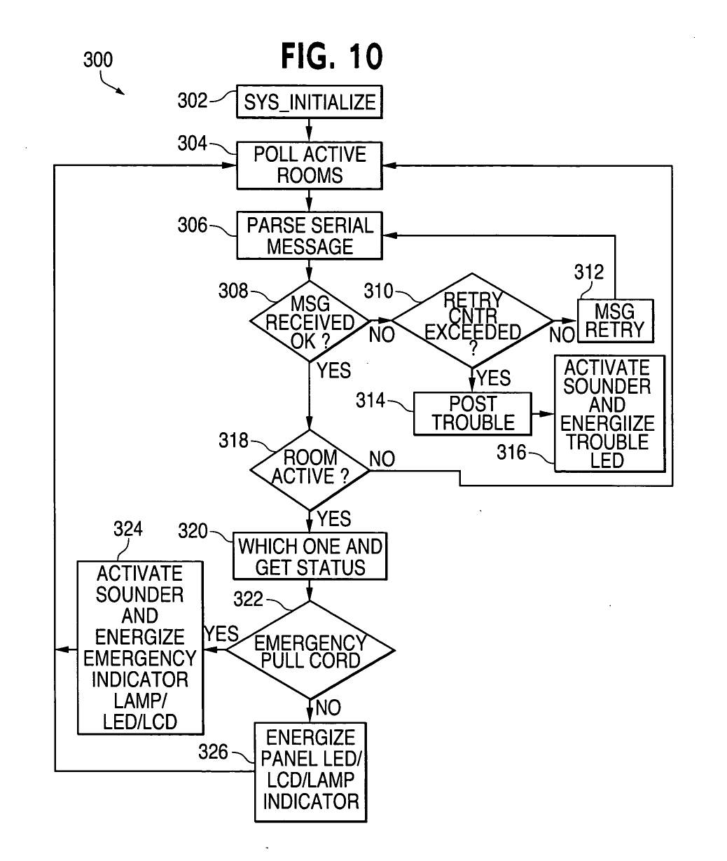

FIG. 10 is a flowchart 300 showing process flow during normal use of an MSM master controller 234. After initialization 302, the program directs the master controller to poll active rooms 304. This is sequential, with at least one pass through one of the loops for each room polled. After a next room is polled, the response from the room is parsed 306 to verify integrity. If an error-free message is not received 308, then a check is made for excess retries 310. If a next retry is permitted, then it is attempted 312, as a result of which the message so received is again parsed. This loop may continue in event of a bad message until retry count is exceeded 310, which causes a trouble report to be posted 314, and audible/visible error messages to be presented 316. Once the fault has been announced, polling resumes 304 with the next room.

In the case where the message is parsed 306 and received successfully 308, the room switch status is read out of the message 318. If there is no activity, the loop is repeated for the next room. In the case where there is room activity 318, the room number and switch status details are extracted from the message 320. If the activity is Emergency Pull Cord 322, then the sounder and emergency lamp are activated 324, after which normal loopback resumes and the next room is polled 304. If the activity is not Emergency Pull Cord, then the energization status of the appropriate panel indicator is changed 326 and the next room is polled 304.

It may be observed that the flow chart described provides a summary of normal operation of the system. This routine 300 proceeds continuously, while additional support processes, such as checksum generation and analysis, new satellite controller 212 activation, and the like operate according to schedules or by interrupt as required.

It may be further observed that the status of a patient room is available outside the room. A further application of positionally and color coded multiple-state information allows indicators in a corridor to be activated to allow staff to note status without requiring a return to a central station. The instant invention can support this efficiency enhancement by maintaining continuous supervision of equipment condition and by providing emergency monitoring, which can allow staff to reduce unnecessary detours.

Sufficient bandwidth may be available in some embodiments to permit two-way voice communication between a master controller 234 and a satellite controller 212. This may be implemented in many ways, such as by including a microphone at each of the controllers and digitizing detected sounds. A series of signal samples taken at a sufficiently high data rate (on the order of 2000 samples per second, for example) and transmitted using coder/decoder (CODEC) technology or another signal management process, can adequately reconstruct voice sent using a digital transmission line. Playback may require decoding at approximately the original sampling rate. Bidirectional, nearly real-time conversation can be managed between a master controller 234 and a satellite controller 212 along with management of all other satellite controllers 212 on a network, if the system bit rate is calculated to accommodate the required data rates. A similar function can be used to allow the master controller to broadcast announcements to a selected group of satellite controllers 212.

Although an example of the master controller 260 is shown using a dedicated microprocessor 262 with internal flash ROM for program and data storage, as well as RAM for volatile data storage, it will be appreciated that a general purpose microcomputer, such as a personal computer, which may have a fixed disk as the basis for both its operating system and any needed volatile data backup storage, and which may further employ dynamic RAM for active program and data storage, may be preferred. Also, although the master 234 and satellite 212 controllers herein described may be useful in a doctor's office to help in the management of services provided to patients in multiple examining rooms, they may also be suited for use in hospitals, convalescent homes, rapid medical response facilities, medical laboratories, and other medical-related facilities, as well as in hotels, schools, cruise ships, subway trains, sports clubs, and other public accommodations wherein central coordination facilities support multiple separate facilities with multiple functions per facility.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to that fall within the scope of the invention.

1. A monitor system, comprising:
a master controller;
a satellite controller distal to said master controller;
a bused communications interconnect that links said master controller and said satellite controller; and
a message protocol configured to transmit data over said bused communications interconnect.

2. The monitor system of claim 1, wherein said master controller is one of a medical staff management annunciator, a nurse's station annunciator, and an examining room service status annunciator.

3. The monitor system of claim 1, wherein said master controller further comprises a communication transceiver that transmits messages and receives messages.

4. The monitor system of claim 1, wherein said satellite controller further comprises a communication transceiver that receives messages and transmits messages.

5. The monitor system of claim 1, further comprising a master display whereon information regarding at least one satellite controller is displayed.

6. The monitor system of claim 1, further comprising a satellite control panel wherein commands are input by sensors selected from the group consisting of electrical, mechanical, and acoustical.

7. The monitor system of claim 1, wherein said bused communications interconnect further comprises one selected from the group consisting essentially of a single shielded twisted pair of controlled-impedance wires, a single pair of wires, a single coaxial line, and a fiber optic data line.

8. The monitor system of claim 1, wherein said bused communications interconnect is branched as required to provide a common connection to all of a set of terminal devices including a master controller and at least one satellite controller.

9. The monitor system of claim 8, wherein said bused communications interconnect further comprises an electrical signal line termination device.

10. The monitor system of claim 1, wherein said bused communications interconnect further comprises one of a wireless nonradiative communication interconnect using bidirectional power line modulation message transmission and reception, and a multiplicity of radio transceivers operating on one of a single, common frequency and a multiplicity of frequencies, wherein said bused communications interconnect provides signal connectivity to all of a set of terminal devices including a master controller and at least one satellite controller.

11. The monitor system of claim 1, wherein said master controller further comprises at least one Ethernet® compatible communications port.

12. The monitor system of claim 1, wherein content to be displayed on said master display is provided by said master controller, and wherein said master display displays a status indication for at least one satellite controller.

13. The monitor system of claim 1, wherein said bused communications interconnect performs interchange of data between said master controller and said satellite controller.

14. The monitor system of claim 1, wherein said message protocol further comprises a polling system wherein a master controller periodically transmits a separate polling message addressed to each possible address in a system.

15. The monitor system of claim 14, wherein said polling system further comprises a response to said separate polling message by said satellite controller assigned to each physically present unit address, wherein said response further comprises transmission of a response message comprising a satellite controller system status report by said satellite controller.

16. The monitor system of claim 15, wherein said response message further comprises a check sum data string associated with at least one of said unit address, said command received from said master controller, and a satellite control panel status report compiled by said satellite controller.

17. A monitor system, comprising:
means for polling a satellite controller with a master controller over a common bused communication medium, wherein the bused communication medium is configured to be linked to a plurality of satellite controllers;
means for transmitting a response from the satellite controller in response to the polling; and means for determining a status of the satellite controller based upon the response.

18. The monitor system of claim 17, further comprising:
means for recognizing positional significance of individual message elements within a digital message communicated via said electromagnetic communication means.

19. The monitor system of claim 17, further comprising:
means for signaling emergency status using a lanyard-style human interface means; and
means for canceling emergency status using a reset control input means located within a distal station.

20. The monitor system of claim 17, further comprising means for verifying message integrity using checksum computation means.

21. A method for operating a remote indicator, comprising:
transmitting data from a master controller to a satellite controller over a common bused communication medium, wherein the bused communications medium is configured to be linked from a master controller to a plurality of satellite controllers;
receiving the data at the satellite controller;
analyzing the data at the satellite controller; and
responding in a predetermined manner in response to the analyzed data.

22. The method of claim 21, wherein the data transmitted by the master controller comprises at least one of a start-of-transmission symbol, a satellite address, a polling command symbol, an end-of-transmission symbol, and a check sum block.

23. The method of claim 21, wherein the data transmitted by the satellite controller comprises at least one of a start-of-transmission symbol, a satellite address, an echo of a polling command symbol, a status data block, an end-of-transmission symbol, and a check sum block.

24. The method of claim 21, wherein the transmitting of data from a master controller further comprises:
transmitting a start-of-transmission symbol;
transmitting a satellite address;
transmitting a polling command symbol;
transmitting an end-of-transmission symbol; and
transmitting a check sum block.

25. The method of claim 21, wherein the transmitting of data from a satellite controller further comprises:
transmitting a start-of-transmission symbol;
transmitting a satellite address;
transmitting a polling command symbol;
transmitting a status block;
transmitting an end-of-transmission symbol; and
transmitting a check sum block.

26. The method of claim 21, further comprising receiving a status response from the satellite controller at the master controller.

27. The method of claim 21, further comprising displaying the status of the satellite controller at the master controller.

28. The method of claim 21, further comprising polling the satellite controller upon activation of the master controller.
